(19) United States
(12) Patent Application Publication
(10) Pub. No.: US 2006/0007145 A1
(43) Pub. Date: Jan. 12, 2006

(54) Computer mouse device

(76) Inventors: Herschel Naghi, Los Angeles, CA (US); Craig S. Erickson, Stevenson Ranch, CA (US); Amir Navid, Sherman Oaks, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/862,766

(22) Filed: Jun. 7, 2004

(51) Int. Cl. G09G 5/08

(52) U.S. Cl. 345/163

(57) ABSTRACT

A computer mouse device for manipulating icons on a computer screen includes a mouse housing including a palm area with multiple outlet holes therein to allow air to move from an inside of the housing to an outside of the housing; means for manipulating icons on a computer screen; and an internal fan assembly within the mouse housing to move air through the multiple holes in the palm area from the inside of the housing to the outside of the housing to cool a user's palm.

### FIELD OF THE INVENTION

The present invention is in, in general, in the field of hand-held controllers such as controllers used to manipulate icons on a video screen, and, in particular, in the field of computer mouse controllers.

### BACKGROUND OF THE INVENTION

U.S. Pat. No. 6,241,247 describes a controller for manipulating icons on a video display. The controller reduces or substantially eliminates perspiration on the user's hands during extended use. The controller includes a housing with finger operated buttons that control the video game. The housing includes ventilation holes to allow air to circulate through the controller and between the housing and the user's hands. The housing encloses electronic components that are contained in a protective package that can be removed from the housing so that it can be easily and thoroughly cleaned. The ventilation holes may be located over the entire housing or may be located only at locations on the housing that are intended to be grasped by the user.

### SUMMARY OF THE INVENTION

The present invention represents an improvement over the controller described above. An aspect of the present involves a computer mouse device for manipulating icons on a computer screen. The computer mouse device includes a mouse housing including a palm area with multiple outlet holes therein to allow air to move from an inside of the housing to an outside of the housing; means for manipulating icons on a computer screen; and an internal fan assembly within the mouse housing to move air through the multiple holes in the palm area from the inside of the housing to the outside of the housing to cool a user's palm.

Implementations of the above aspect of the invention may include one or more of the following. The multiple holes include a left set of holes corresponding to a left side of a user's palm and a right set of holes corresponding to a right side of a user's palm. Multiple fan intake holes in the mouse housing to draw air into the inside of the mouse housing. The mouse housing includes a lower front portion and the multiple fan intake holes are located in the lower front portion of the mouse housing. The mouse housing includes a left finger area and a right finger area on opposite sides of the mouse housing where the fingers of a user engage the mouse housing, at least one of the left finger area and the right finger area including multiple outlet holes therein to allow air to move from an inside of the housing to an outside of the housing in the finger area. Both the left finger area and the right finger area include the multiple outlet holes therein. At least one of the left finger area and the right finger area include at least one spacer to space the user's fingers from the multiple outlet holes. The internal fan assembly is a multi-speed fan assembly and further including a multi-position switch to control the multi-speed fan assembly.

Another aspect of the invention involves a computer mouse device for manipulating icons on a computer screen. The computer mouse device includes a mouse housing including opposite sides with a left finger area and a right finger area where the fingers of a user engage the mouse housing, at least one of the left finger area and the right finger area including multiple outlet holes therein to allow air to move from an inside of the housing to an outside of the housing; means for manipulating icons on a computer screen; and an internal fan assembly within the mouse housing to move air through the multiple outlet holes in the finger area from the inside of the housing to the outside of the housing.

Implementations of the aspect of the invention described immediately above may include one or more of the following. Multiple fan intake holes in the mouse housing to draw air into the inside of the mouse housing. The mouse housing includes a lower front portion and the multiple fan intake holes are located in the lower front portion of the mouse housing. Both the left finger area and the right finger area include the multiple outlet holes therein. At least one of the left finger area and the right finger area include at least one spacer to space the user's fingers from the multiple outlet holes. The internal fan assembly is a multi-speed fan assembly and further including a Multi-position switch to control the multi-speed fan assembly.

Further objects and advantages will be apparent to those skilled in the art after a review of the drawings and the detailed description of the preferred embodiments set forth below.

### BRIEF DESCRIPTION OF THE DRAWINGS

FIG. 1 is a perspective view of an embodiment of a computer mouse device.

FIG. 2 is a front elevational view of the computer mouse device illustrated in FIG. 1.

FIG. 3 is a top plan view of the computer mouse device illustrated in FIG. 1.

FIG. 4 is a right side elevational view of the computer mouse device illustrated in FIG. 1.

FIG. 5 is a bottom plan view of the computer mouse device illustrated in FIG. 1.

FIG. 6 is a right side elevational view of the computer mouse device illustrated in FIG. 1.

FIG. 7 is an exploded perspective view of the computer mouse device illustrated in FIG. 1.

FIG. 8 is an exploded perspective view of a bottom of the computer mouse device illustrated in FIG. 1 and some of the internal components.

### DETAILED DESCRIPTION OF PREFERRED EMBODIMENTS

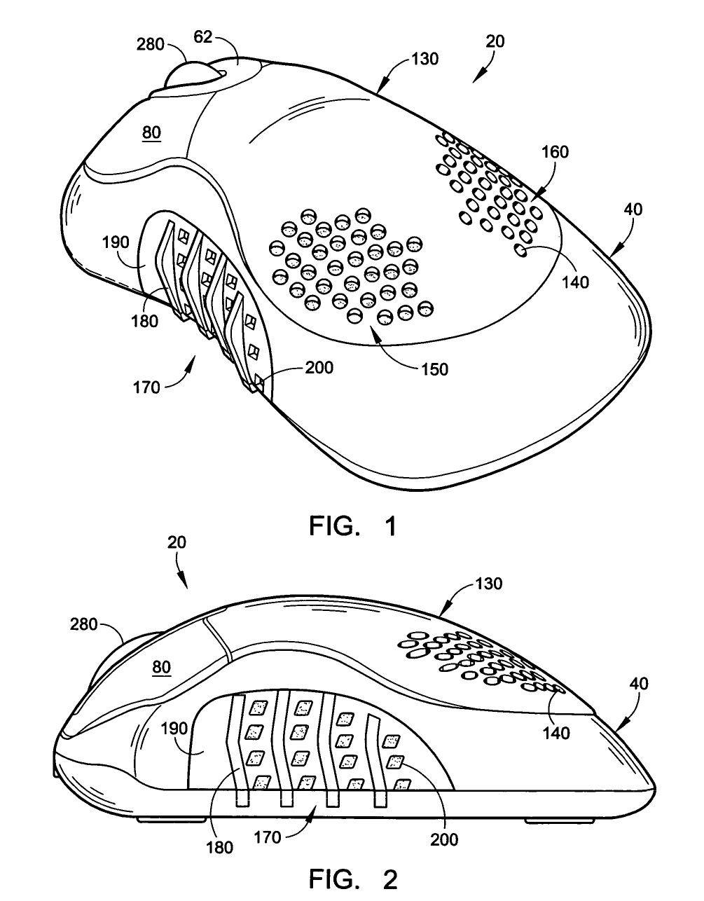

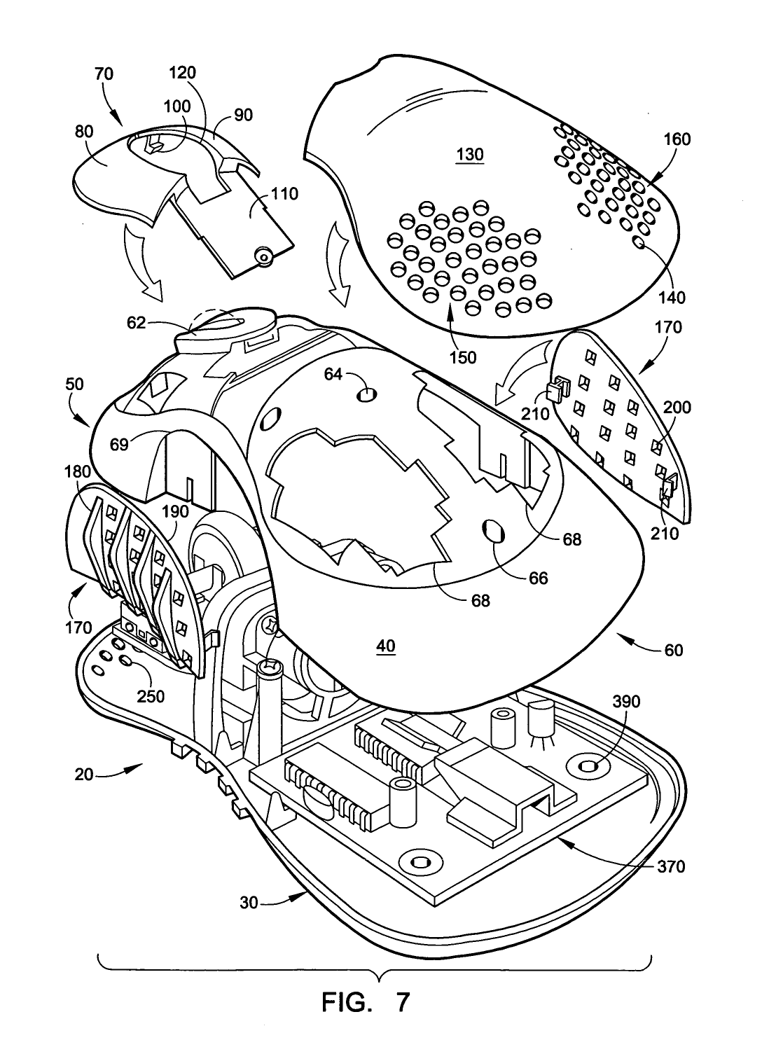

With reference to FIGS. 1-8, and initially FIGS. 1 and 7, a computer mouse device 20 constructed in accordance with an embodiment of the invention will now be described. The computer mouse device 20 includes a housing that houses electronics for operation of the mouse and an internal fan. Among other elements, the housing includes a base plate 30 and an upper shell 40. The upper shell 40 includes a front portion 50 and a rear portion 60. The front portion 50 includes a scroll wheel support plate 62. The rear portion 60 includes button plate screw port 64, rubber grip attachment port 66, and air holes 68. Air gaps 69 are disposed on opposite lateral sides of the upper shell 40.

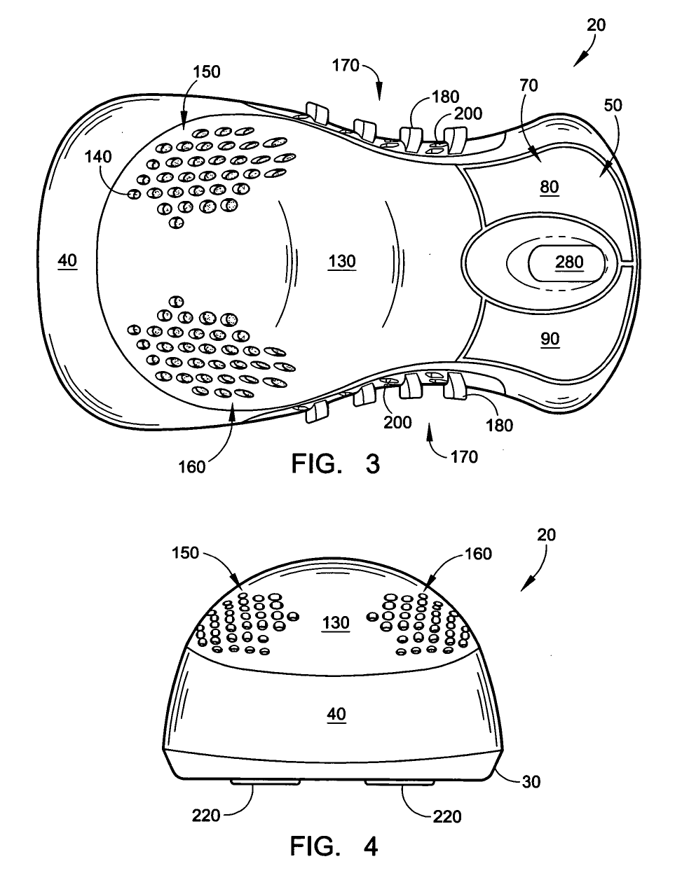

With reference additionally to FIGS. 3 and 6, the front portion 50 carries a button plate 70 around scroll wheel support plate 62. The button plate 70 includes a left button surface 80, a right button surface 90, an attachment prong 100, a tab 110, and a central hole 120 to accommodate the scroll wheel support plate 62. The button plate 70 is connected to the upper shell 40 with a threaded fastener extending through button plate screw port 64.

With reference back to FIG. 3, the rear portion 60 carries a dual-injected rubber and plastic grip palm rest 130. The palm rest 130 includes two sets of palm ventilation holes 140: a left set 150 disposed over left air hole 68 and a right set 160 disposed over right air hole 68. Although two sets of ventilation holes 140 are shown, in alternative embodiments, other numbers of sets of ventilation holes 140 may be provided (e.g., 1, 3, 4, 5, etc.). Further, although the palm ventilation holes 140 are shown as being circular, in alternative embodiments, the holes 140 may have one or more different configurations. The palm rest 130 is connected to the upper shell 40 with a threaded fastener extending through rubber grip attachment port 66.

With reference to FIGS. 1, 2, 3, and 7, raised rubber and plastic grips 170 are disposed over the air gaps 69 on opposite lateral sides of the upper shell 40. The grips 170 include longitudinally spaced, vertical spacers or ribs 180 that extend outwardly from a plate 190 of the grip 170. The plate 190 includes vertically spaced side ventilation holes 200 between the ribs 180. Although the ribs 180 are shown as being vertical, in alternative embodiments, the ribs 180 may take one or more alternative configurations that extend outwardly from the plate 190. Important aspects of the ribs 180 are that they provide a location for a user's fingers to engage the mouse device 20 and they space the user's fingers from the ventilation holes 200 so that the fingers do not block the ventilation holes 200, allowing the fingers to be air cooled. Although the ventilation holes 200 are shown as being rectilinear and vertically spaced, in alternative embodiments, the ventilation holes 200 may have one or more different configurations and/or may be arranged in one or more different arrangements. Attachment prongs 210 extend inwardly from the plate 190 for connecting the vented grip 170 to the rest of the mouse device 20.

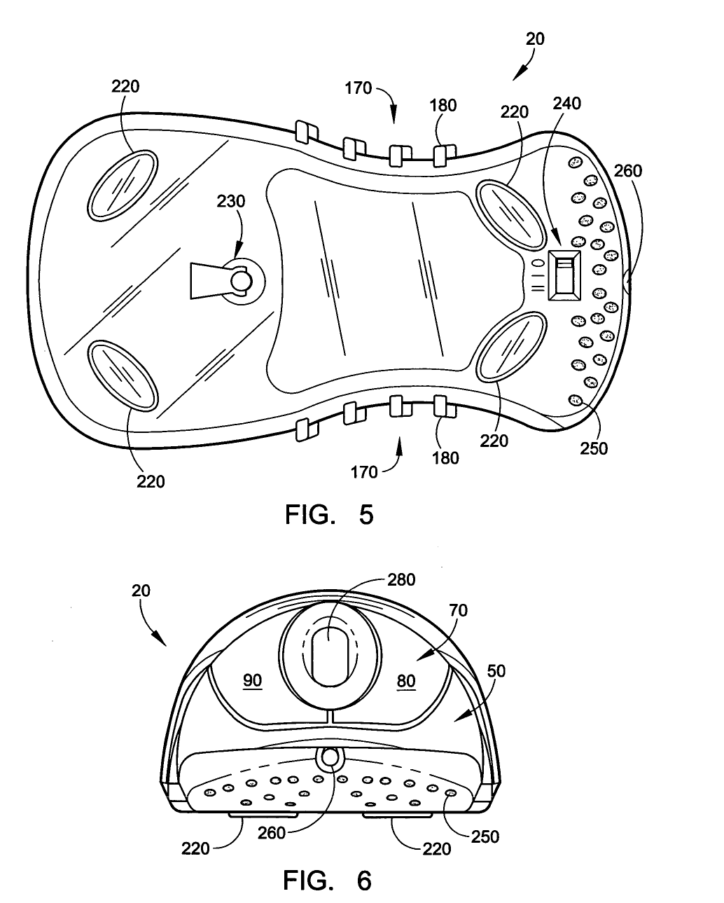

With reference to FIGS. 5 and 6, an underside of the base plate 30 carries four smooth surface sliders 220 near opposite corners of the computer mouse device 20. Although four sliders 220 are shown, in alternative embodiments of the computer mouse device 20, other numbers of sliders 220 may be used. A red LED high-resolution optical sensor 230 is carried by the underside of the base plate 30 in a rear central area of the base plate 30. Near a front end of the underside of the base plate 30, a fan level switch 240 is carried by the computer mouse device 20. In the embodiment shown, the switch 240 may be switched between 1) a fan off condition, 2) a low-speed fan condition, and 3) a high-speed fan condition. In alternative embodiments, the computer mouse device 20 may have the switch 240 located in another location, the device 20 may not include a switch (i.e., fan may always be on at a constant speed), or the switch 240 may have other numbers of switch positions (e.g., 2, 4, etc.). Closer to a front end of the underside of the base plate 30, the computer mouse device 20 includes multiple fan intake vents 250. Positioning the fan intake vents 250 and the fan assembly 330 in the locations shown inhibits the user from hearing fan noise (any noise is directed outward, away from the user), and causes air to travel across the circuit board 370 allowing for cooler operation and a longer anticipated operational life.

Holes 140, 200, 250 may have a filter or screen thereunder to prevent dirt and other debris from entering the inside of the housing. As best shown in FIG. 6, a cord assembly support 260 is disposed at the front end of the computer mouse device 20 for connection of a mouse cord for powering electronics of the computer mouse device 20 and transmitting signals from the computer mouse device 20.

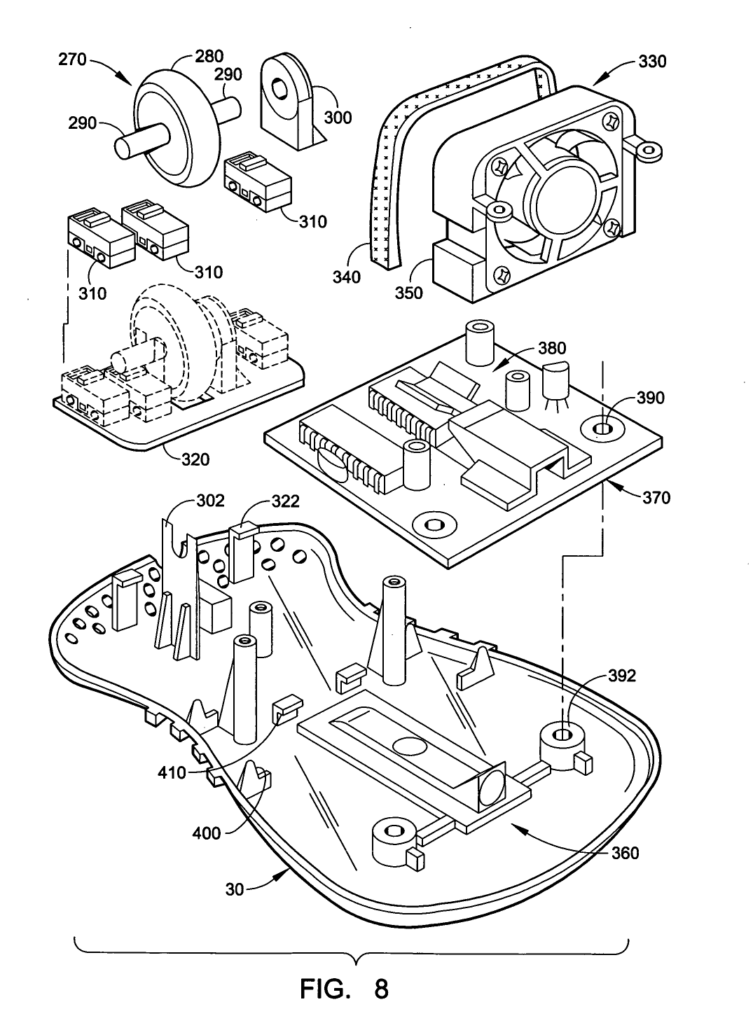

With reference to FIG. 8, a number of internal components of the computer mouse device 20 will now be described. A scroll wheel assembly 270 is disposed within the upper shell 40 near a front part of the computer mouse device 20. The scroll wheel assembly 270 includes a scroll wheel 280 with oppositely extending wheel posts 290. The wheel posts 290 are rotationally disposed within scroll wheel guides 300, 302. Scroll wheel sensors 310 are used to sense movement of the scroll wheel and transform this movement into electrical signals. The scroll wheel 280, scroll wheel guide 300, and scroll wheel sensors 310 are disposed on a scroll wheel support 320. The scroll wheel assembly 270 is secured to the base plate 30 with scroll wheel secure prongs 322. Rearward of the scroll wheel assembly 270, a fan assembly 330 with a bearingless, brushless fan 300 is disposed. The fan assembly 330 includes a fan bracket 340, a fan support assembly 350, and a multi-speed fan motor (not shown). Rearward of the fan assembly 330 and above an optical sensor housing 360, a printed circuit board 370 with optical sensor assembly 380 is disposed. The printed circuit board 370 with optical sensor assembly 380 may be used to translate movement of the mouse observed with the optical sensor 230 into signals for controlling icon movement on a computer screen. The printed circuit board 370 includes screw holes 390 that align with screw posts 392 of the base plate 30 for connecting the printed circuit board 370 to the base plate 30. Assembly guides 400 and printed circuit board secure prongs 410 of the base plate 30 are used to secure the printed circuit board 370 to the base plate 30.

The computer mouse device 20 will now be described in use. To activate the fan assembly 330, the user the turns the computer mouse device 20 over and switches the fan level switch 240 to the position “I”, the low fan speed position, or position “II”, the high fan speed position. In position “I” or position “II”, power delivered through the mouse cord is used to run the motor/fan to the appropriate speed level. The computer mouse device 20 is then turned over so that the smooth surface sliders 220 are placed face-down on a flat surface (e.g., mouse pad, table) and the computer mouse device 20 is oriented as shown in FIG. 1. In the event of a right-handed user, the user's hand is placed on the computer mouse device 20 so that the left portion of a user's palm is over the left set 150 of palm ventilation holes 140 and the right portion of a user's palm is over the right set 160 of palm ventilation holes 140. The user's thumb is placed on the left raised rubber and plastic grip 170 and the user's middle finger (or third finger) is placed on the right raised rubber and plastic grip 170. The fan assembly 330 draws air into the computer mouse device 20 through the fan intake vents 250 and blows air out of the computer mouse device 20 through the left set 150 of palm ventilation holes 140, the right set 160 of palm ventilation holes 140, and the ventilation holes 200 of the left and right raised rubber and plastic grips 170. The ribs 180 of the raised rubber and plastic grips 170 provide a location for a user's fingers to engage the mouse device 20 and they space the user's fingers from the ventilation holes 200 so that the fingers do not block the ventilation holes 200, allowing the fingers to be air cooled. Although not shown, the palm rest 130 may include one or more spacers to space the user's palm from the holes 140. Air emitted out of the computer mouse device 20 through the left set 150 of palm ventilation holes 140 and the right set 160 of palm ventilation holes 140 cools the user's palm area, inhibiting the production of perspiration in this area. The left button 80, the right button 90, the scroll wheel 280, and the optical sensor 230 are used in a manner well known in the computer mouse field and, therefore, will not be described in further detail.

It will be readily apparent to those skilled in the art that still further changes and modifications in the actual concepts described herein can readily be made without departing from the spirit and scope of the invention as defined by the following claims.

What is claimed is:

1. A computer mouse device for manipulating icons on a computer screen, comprising:
a mouse housing including a palm area with multiple outlet holes therein to allow air to move from an inside of the housing to an outside of the housing;
means for manipulating icons on a computer screen; and
an internal fan assembly within the mouse housing to move air through the multiple holes in the palm area from the inside of the housing to the outside of the housing to cool a user's palm.

2. The computer mouse device of claim 1, wherein the multiple holes include a left set of holes corresponding to a left side of a user's palm and a right set of holes corresponding to a right side of a user's palm.

3. The computer mouse device of claim 1, further including multiple fan intake holes in the mouse housing to draw air into the inside of the mouse housing.

4. The computer mouse device of claim 3, wherein the mouse housing includes a lower front portion and the multiple fan intake holes are located in the lower front portion of the mouse housing.

5. The computer mouse device of claim 1, wherein the mouse housing includes a left finger area and a right finger area on opposite sides of the mouse housing where the fingers of a user engage the mouse housing, at least one of the left finger area and the right finger area including multiple outlet holes therein to allow air to move from an inside of the housing to an outside of the housing in the finger area.

6. The computer mouse device of claim 5, wherein both the left finger area and the right finger area include the multiple outlet holes therein.

7. The computer mouse device of claim 5, wherein at least one of the left finger area and the right finger area include at least one spacer to space the user's fingers from the multiple outlet holes.

8. The computer mouse device of claim 1, wherein the internal fan assembly is a multi-speed fan assembly and further including a multi-position switch to control the multi-speed fan assembly.

9. A computer mouse device for manipulating icons on a computer screen, comprising:
a mouse housing including opposite sides with a left finger area and a right finger area where the fingers of a user engage the mouse housing, at least one of the left finger area and the right finger area including multiple outlet holes therein to allow air to move from an inside of the housing to an outside of the housing;
means for manipulating icons on a computer screen; and
an internal fan assembly within the mouse housing to move air through the multiple outlet holes in the finger area from the inside of the housing to the outside of the housing.

10. The computer mouse device of claim 9, further including multiple fan intake holes in the mouse housing to draw air into the inside of the mouse housing.

11. The computer mouse device of claim 9, wherein the mouse housing includes a lower front portion and the multiple fan intake holes are located in the lower front portion of the mouse housing.

12. The computer mouse device of claim 9, wherein both the left finger area and the right finger area include the multiple outlet holes therein.

13. The computer mouse device of claim 9, wherein at least one of the left finger area and the right finger area include at least one spacer to space the user's fingers from the multiple outlet holes.

14. The computer mouse device of claim 9, wherein the internal fan assembly is a multi-speed fan assembly and further including a multi-position switch to control the multi-speed fan assembly.
